(19) United States
(12) Patent Application Publication
(10) Pub. No.: US 2026/0003531 A1
(43) Pub. Date: Jan. 1, 2026

(54) DATA MIGRATION METHOD BASED ON STORAGE CLUSTER, SYSTEM AND STORAGE MEDIUM

(71) Applicant: Beijing Volcano Engine Technology Co., Ltd., Haidian District (CN)

(72) Inventors: Yutian YANG, Beijing (CN); Haibin SHE, Beijing (CN); Xingchen YI, Beijing (CN); Qingyang ZHANG, Beijing (CN); Wei LI, Beijing (CN); Pengwei ZHAO, Beijing (CN); Haijia SHEN, Beijing (CN); Fenghao ZHANG, Beijing (CN); Xianghui ZHOU, Beijing (CN)

(21) Appl. No.: 19/175,428

(22) Filed: Apr. 10, 2025

(30) Foreign Application Priority Data
Jun. 28, 2024 (CN) 202410867224.6

(51) Int. Cl. G06F 3/06

(52) U.S. Cl. CPC G06F 3/0647; G06F 3/0619; G06F 3/0634; G06F 3/0659; G06F 3/067

(57) ABSTRACT

The present disclosure discloses a data migration method and a system based on a storage cluster, and a storage medium. The method includes: triggering a dual write mode of a block storage access client in response to a data migration instruction, and implementing incremental data synchronization to a source storage cluster and a target storage cluster by executing the dual write mode, where the data migration instruction is used to instruct to migrate data in the source storage cluster to the target storage cluster; and triggering a storage node in the source storage cluster to generate corresponding snapshot data for existing data in response to the data migration instruction, and migrate the snapshot data to the target storage cluster.

### CROSS-REFERENCE TO RELATED APPLICATION

The present application claims priority and benefits to a Chinese patent application No. 202410867224.6, filed on Jun. 28, 2024. The full content of the above Chinese patent application is hereby incorporated by reference as a part of the present application.

### TECHNICAL FIELD

The present disclosure relates to a data migration method based on a storage cluster, a system and a storage medium.

### BACKGROUND

At present, cloud computing vendors usually provide an EBS (Elastic Block Storage) service, which provides users with the capability of dynamically allocating and adjusting storage resources. This EBS service enables users to quickly expand or contract storage resources according to changes in business requirements, which imposes high requirements for the operation and maintenance capabilities of the cloud computing vendor. It is necessary to comprehensively consider storage capacity and performance, and dynamically schedule storage resources. In practical applications, data migration through EBS can perform secondary scheduling on a block device that has been created to realize dynamic scheduling of storage resources.

For example, when data in a storage cluster needs to be migrated to another storage cluster, data migration can be realized by setting a data migration Agent module to continuously compare data between block devices in the two storage clusters and perform data synchronization. However, in this way, in order to ensure data consistency, during the last data synchronization, the block device of the storage cluster cannot process new IO (Input/Output) requests, and the IO request interruption time that can be perceived by the user is long.

### SUMMARY

In view of this, embodiments of the present disclosure provide a data migration method and system based on a storage cluster, and a storage medium.

An embodiment of the present disclosure provides a data migration method based on a storage cluster. The method includes:

triggering a dual write mode of a block storage access client in response to a data migration instruction, and implementing incremental data synchronization to a source storage cluster and a target storage cluster by executing the dual write mode, where the data migration instruction is used to instruct to migrate data in the source storage cluster to the target storage cluster; and

triggering a storage node in the source storage cluster to generate corresponding snapshot data for existing data in response to the data migration instruction, and migrate the snapshot data to the target storage cluster.

An embodiment of the present disclosure provides a data migration system based on a storage cluster. The system includes:
a plurality of storage clusters and a management server configured to manage and control the plurality of storage clusters, where
the management server is configured to: trigger a dual write mode of a block storage access client in response to a data migration instruction, and implement incremental data synchronization to a source storage cluster and a target storage cluster by executing the dual write mode, where the data migration instruction is used to instruct to migrate data in the source storage cluster to the target storage cluster; and trigger a storage node in the source storage cluster to generate corresponding snapshot data for existing data in response to the data migration instruction, and migrate the snapshot data to the target storage cluster.

An embodiment of the present disclosure provides a computer-readable storage medium. The computer-readable storage medium stores instructions which, when executed by a terminal device, cause the terminal device to perform the data migration method based on a storage cluster as described above.

### BRIEF DESCRIPTION OF DRAWINGS

FIG. 1 is a schematic diagram of a scenario of data migration based on a storage cluster according to an embodiment of the present disclosure.

FIG. 2 is a schematic diagram of a method for data migration based on a storage cluster in the prior art.

FIG. 3 is a schematic diagram of an exemplary application scenario provided by an embodiment of the present disclosure.

FIG. 4 is a flowchart of a method for data migration based on a storage cluster provided by an embodiment of the present disclosure.

FIG. 5 is a schematic diagram of a method for data migration based on a storage cluster in an embodiment of the present disclosure.

FIG. 6 is a schematic diagram of a process of data migration after an EBS client turns on a dual write mode in an embodiment of the present disclosure.

FIG. 7 is a schematic diagram of sending a write request in a dual write mode in the prior art.

FIG. 8 is a schematic diagram of sending a write request in a dual write mode in an embodiment of the present disclosure.

FIG. 9 is a schematic diagram of a two-stage write mode switching mechanism provided by an embodiment of the present disclosure.

FIG. 10 is a schematic diagram of a system for data migration based on a storage cluster provided by an embodiment of the present disclosure.

### DETAILED DESCRIPTION

To make the above objects, features, and advantages of the embodiments of the present disclosure more comprehensible, the embodiments of the present disclosure are described in further detail below with reference to the drawings and specific implementations.

In order to facilitate understanding and explanation of the technical solutions provided by the embodiments of the present disclosure, technical terms that may be involved in the embodiments of the present disclosure are explained below.

Elastic Computing Service (ECS): an elastic computing service provided by a cloud computing vendor.

Elastic Block Storage (EBS): an elastic block storage service provided by a cloud computing vendor.

Node: a server in ECS and EBS.

Virtual Machine (VM): a virtual machine provided by a cloud computing vendor. For example, a VM may be provided in an ECS node.

Cluster: a management unit including a plurality of nodes in ECS and EBS.

Availability zone (AZ): a management unit having an independent power supply and network resources in a cloud computing scenario, which may include a plurality of clusters.

Block device: a virtual block device provided by EBS.

Device segment: a block device is divided into segments according to a fixed size. For example, a block device is divided into segments according to a fixed size of 32 GB.

Storage node: a process that provides read and write services in the granularity of a device segment and is deployed on each storage node.

EBS Client: an EBS access module deployed on an ECS node and responsible for forwarding an IO request to a backend EBS cluster.

Snapshot: data of a block device at a certain point of time.

IO Hang: an IO request cannot succeed in a retry process.

Snapshot rebase: snapshot data is used as the earliest data in a certain block device in time sequence.

DMA (Direct Memory Access): a memory access technology that allows hardware to directly access a memory without intervention of a CPU (Central Processing Unit). This technology is often used by hardware to accelerate an IO request.

In order to facilitate understanding and explanation of the technical solutions provided by the embodiments of the present disclosure, the background art of the embodiments of the present disclosure is described below.

The EBS service enables users to quickly expand or contract storage resources according to changes in business requirements without prior planning and purchasing a fixed number of storage devices. This imposes high requirements for the operation and maintenance capabilities of the cloud computing vendor. It is necessary to comprehensively consider storage capacity and performance, and evenly distribute storage resources used by users to a plurality of clusters in the same availability zone (AZ) to achieve full utilization of storage resources. In addition, with the evolution and iteration of technologies in the field of storage, storage media and servers with better performance and lower cost will gradually replace old servers. As a storage service provider, it is necessary to ensure the durability and reliability of user data, and avoid interference with the use by users and impact on user services as much as possible. EBS data migration is essential for meeting the above requirements. Through data migration, secondary scheduling can be performed on a block device that has been created to achieve a balance between capacity and performance of existing clusters. In view of the updating of servers, data migration can also be completed transparently without interrupting user services.

FIG. 1 illustrates a schematic diagram of a scenario of data migration. A virtual machine (VM) in an ECS cluster can access block devices in different clusters through an EBS client, that is, the VM can send an IO request to an EBS cluster through the EBS client. The IO request includes a read request, a write request, and the like. When data in a block device A in an EBS cluster A is migrated to a block device B in an EBS cluster B, different EBS clusters are accessed before and after the migration, but the data is consistent. At the same time, it is necessary to be as transparent to users as possible, and automatically complete switching of an access link.

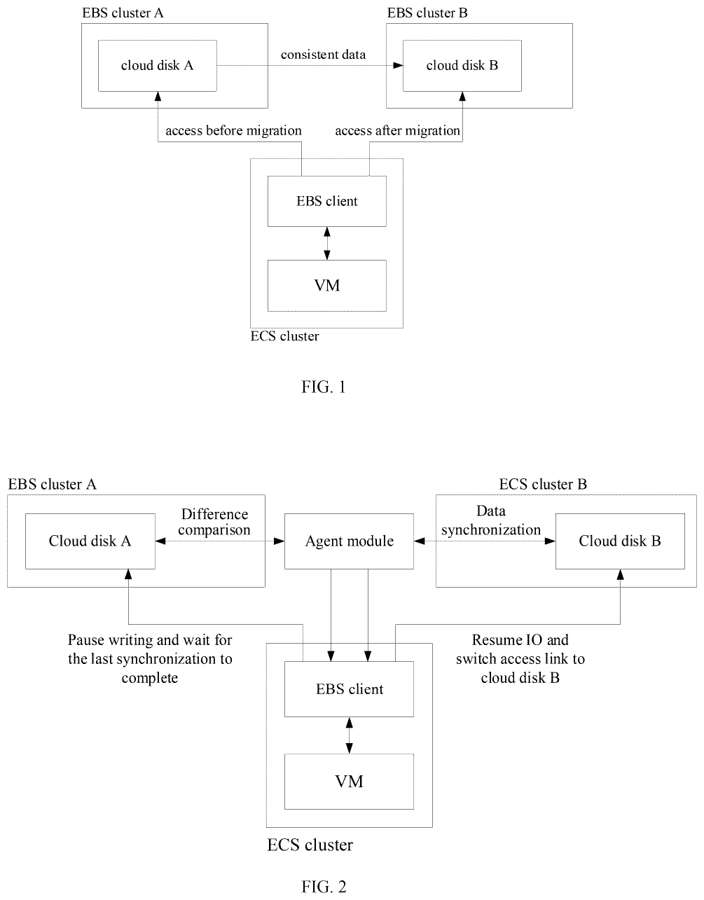

FIG. 2 illustrates a schematic diagram of a method for data migration in the prior art. In the prior art, data migration is implemented by setting a data migration Agent module to continuously compare data between block devices in two EBS clusters and perform data synchronization. Specifically, a process of implementing data migration includes: comparing, by the Agent module, a data difference, reading differential data in the block device A and writing the differential data into a block device B, and continuously performing data synchronization; notifying, by the Agent module, the EBS client to pause writing and hanging a newly received IO request when the Agent module finds that the data difference is small enough; performing data synchronization for the last time to reach a synchronous state of data consistency; notifying, by the Agent module, the EBS client to switch an access link to the block device B, and simultaneously resuming foreground writing and re-issuing the previously hanged IO request to the block device B.

However, inventors of the present disclosure have noticed: when the write traffic is large, especially in a high-performance scenario, the IO request interruption time is relatively long, and obvious delay jitter occurs in the data migration process. In the solution of the prior art, in order to ensure data consistency, data cannot continue to be written during the last data synchronization. Otherwise, after the last synchronization is completed, some data newly written into the block device A will be lost on the block device B. The IO request interruption time perceived by the user is the overall time-consuming of the last data synchronization. When the user has a relatively large write throughput, the amount of data synchronized for the last time may be very large, and the estimated influence time is at the second level or above. In addition, the introduction of the Agent module increases the architecture complexity and consumes more resources. In the solution of the prior art, a data migration Agent module is specially set up for data migration and is responsible for data synchronization for migration. In addition, the data needs to go through an extra hop of the network via the Agent module. The concurrency capability of data migration is limited by the number of deployed Agent modules, and more resources are consumed.

The embodiments of the present disclosure provide a data migration method based on a storage cluster, a system and a storage medium. A block storage availability zone management server responds to a data migration instruction to migrate data in a source storage cluster to a target storage cluster. In the process of data migration, a dual write mode of a block storage access client is triggered, and incremental data synchronization to the source storage cluster and the target storage cluster is implemented by executing the dual write mode. The storage node in the source storage cluster is further triggered to generate corresponding snapshot data for existing data and migrate the snapshot data to the target storage cluster. In this way, the existing data is migrated to the target storage cluster through the snapshot data, while the incremental data is directly sent to the source storage cluster and the target storage cluster. Only when the dual write mode of the block storage access client is triggered, the IO request is paused at the microsecond level, and the IO request interruption time in the data migration process is extremely short, which is basically imperceptible to users.

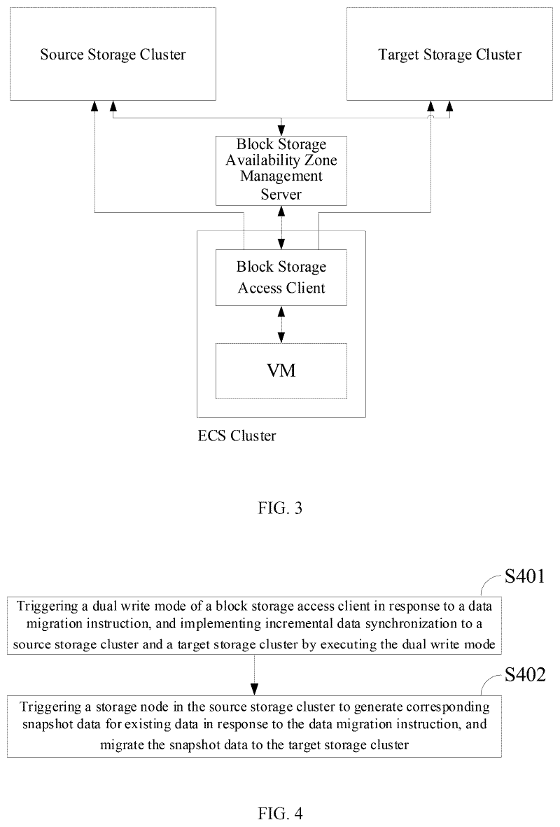

In order to facilitate understanding of the data migration method based on a storage cluster provided by the embodiments of the present disclosure, the following describes the method with reference to the scenario example shown in FIG. 3. Referring to FIG. 3, this figure is a schematic diagram of an exemplary application scenario provided by an embodiment of the present disclosure.

In practical applications, a virtual machine (VM) in an ECS cluster accesses different storage clusters through a block storage access client, that is, the VM can send an IO request to different storage clusters through the block storage access client. The IO request includes a read request, a write request, and the like. In some scenarios, data in a source storage cluster needs to be migrated to a target storage cluster. In the embodiment of the present disclosure, online data migration is implemented by reusing the original capabilities of existing components. The block storage availability zone management server can implement management of all storage clusters, and send a common API (Application Programming Interface) request of a user for the storage cluster to a specific storage cluster, for example, including an operation request related to creating a block device, deleting a block device, modifying a block device, querying a block device, creating a snapshot of a block device, and the like. In the embodiment of the present disclosure, the atomic capability of a snapshot of a storage cluster is reused to complete data replication, and then incremental data synchronization during data migration is ensured by switching a write mode of the block storage access client.

It may be understood by those skilled in the art that the schematic diagram of the framework shown in FIG. 3 is only an example in which the implementations of the present disclosure may be implemented. The scope of the implementations of the present disclosure is not limited by any aspect of the framework.

In order to facilitate understanding of the embodiments of the present disclosure, the following describes a data migration method based on a storage cluster provided by an embodiment of the present disclosure with reference to the drawings.

Referring to FIG. 4, this figure is a flowchart of a data migration method based on a storage cluster provided by an embodiment of the present disclosure. As shown in FIG. 4, the method may include S401-S402.

S401: trigger a dual write mode of a block storage access client in response to a data migration instruction, and implement incremental data synchronization to a source storage cluster and a target storage cluster by executing the dual write mode. In which the data migration instruction is used to instruct to migrate data in the source storage cluster to the target storage cluster.

When data migration is required, a block storage availability zone management server acquires a data migration instruction, and determines a source storage cluster and a target storage cluster before and after the data migration according to the data migration instruction. The data migration instruction is used to instruct to migrate data in the source storage cluster to the target storage cluster, and specifically, data in a source block device of the source storage cluster may be migrated to the target storage cluster. In practical applications, the block storage availability zone management server sends an instruction for creating an empty block device to the target storage cluster. According to the instruction for creating an empty block device, the target storage cluster can create a target block device and feed back related information of the target block device to the block storage availability zone management server. The target block device is used to store data migrated from the source storage cluster.

The block storage availability zone management server can trigger the dual write mode of the block storage access client in response to the data migration instruction, and the block storage access client executes the dual write mode to implement incremental data synchronization to the source storage cluster and the target storage cluster.

For example, an instruction for turning on the dual write mode may be sent to the block storage access client.

In a possible implementation, triggering the dual write mode of the block storage access client may include:
determining a first synchronization point of executing the dual write mode in response to the instruction for turning on the dual write mode, where the first synchronization point is used to instruct to first land all preceding IOs issued before the first synchronization point and then process subsequent IOs issued after the first synchronization point in the dual write mode.

When the write mode is switched, it is necessary to determine a point of time. IOs issued before the point of time all land successfully, and IOs issued after the point of time are all processed in the new write mode. In this way, it can be ensured that some flying IOs will not be missed in the synchronization of the existing data. Therefore, the key to the write mode switching is to determine a synchronization point.

The block storage access client determines the first synchronization point of the IO request in response to the instruction for turning on the dual write mode. The block storage access client determines the first synchronization point of the IO request by briefly hanging the IO request, and preceding IOs issued before the instruction for turning on the dual write mode is received and subsequent IOs issued after the instruction for turning on the dual write mode is received can be distinguished. The preceding IOs issued before the first synchronization point continue to be processed according to the original processing mode and continue to be sent to the source storage cluster, for example, sent to the source block device of the source storage cluster. The subsequent IOs issued after the first synchronization point are processed in the new processing mode and dual write processing is performed. The write data generated by the subsequent IOs is incremental data, so that the incremental data is sent to both the source storage cluster and the target storage cluster at the same time, for example, the incremental data is sent to the source block device of the source storage cluster and the target block device of the target storage cluster at the same time.

The block storage access client feeds back write mode switching completion information to the block storage availability zone management server after finishing processing the preceding IOs issued before the first synchronization point. At this time, the preceding IOs issued before the first synchronization point all land in the source storage cluster, while the newly generated subsequent IOs issued after the first synchronization point have been migrated to the target storage cluster and are also retained in the source storage cluster at the same time.

For the specific implementation process of the block storage access client executing the dual write mode, reference may be made to the following embodiments, which will not be repeated here.

S402, trigger a storage node in the source storage cluster to generate corresponding snapshot data for existing data in response to the data migration instruction, and migrate the snapshot data to the target storage cluster.

The block storage availability zone management server sends an instruction for creating a snapshot for the existing data to the source storage cluster in response to the write mode switching completion information. The storage node in the source storage cluster creates the snapshot data corresponding to the existing data in response to the data migration instruction, for example, a source block device snapshot of the source block device. The snapshot data has snapshot information, which records a creation path of the snapshot data, creation time, and the like. Since the source storage cluster responds to the IOs issued before the first synchronization point, the snapshot is created after the write mode switching completion information is received, and the preceding IOs issued before the first synchronization point have been processed, thereby ensuring the integrity of data in the snapshot data.

The block storage availability zone management server sends the snapshot information of the snapshot data to the target storage cluster, and then the target storage cluster can read the snapshot data from the source storage cluster and copy the snapshot data to the target block device. In the process of copying the snapshot data to the target block device, the target block device may also receive a new IO request in parallel. Especially when the IO request is a write request, in the process of copying the existing data to the target block device, the incremental data is also written into the target block device, and the IO request is not paused under the condition that the data consistency is ensured.

In addition, in the process of copying the snapshot data, the target storage cluster may divide the snapshot data into a plurality of segments and copy the segments of the snapshot data in parallel to improve the speed of copying the snapshot data.

In the embodiments of the present disclosure, the block storage availability zone management server may respond to the data migration instruction to migrate the data in the source storage cluster to the target storage cluster. In the process of data migration, the dual write mode of the block storage access client is triggered, and the incremental data synchronization to the source storage cluster and the target storage cluster is implemented by executing the dual write mode. The storage node in the source storage cluster is further triggered to generate corresponding snapshot data for the existing data and migrate the snapshot data to the target storage cluster. In this way, the existing data is migrated to the target storage cluster through the snapshot data, while the incremental data is directly sent to the source storage cluster and the target storage cluster. Only when the dual write mode of the block storage access client is triggered, the IO request is paused at the microsecond level, and the IO request interruption time in the data migration process is extremely short, which is basically imperceptible to users.

In a possible implementation, the method may further include:
determining a second synchronization point of turning off the dual write mode in response to an instruction for turning off the dual write mode, where the second synchronization point is used to instruct to first land all IOs issued before the second synchronization point in the dual write mode and then process IOs issued after the second synchronization point in the single write mode.

The block storage availability zone management server needs to poll the state of the copied snapshot data when the target storage cluster copies the snapshot data, and may send an instruction for turning off the dual write mode to the block storage access client when it is determined that the snapshot data has been completely copied.

The block storage access client determines the second synchronization point of the IO request in response to the instruction for turning off the dual write mode. The block storage access client determines the second synchronization point of the IO request by briefly hanging the IO request, and IOs issued before the instruction for turning off the dual write mode is received and IOs issued after the instruction for turning off the dual write mode is received can be distinguished. The IOs issued before the instruction for turning off the dual write mode is received are preceding IOs issued before the second synchronization point, which are continuously processed according to the original processing mode and continue to be sent to the source storage cluster and the target storage cluster. The IOs issued after the instruction for turning off the dual write mode is received are subsequent IOs issued after the second synchronization point, which are processed in the new processing mode and single write processing is performed. These IOs are only sent to the target storage cluster.

In practical applications, the block storage availability zone management server may be an available block storage management module. The available block storage management module is a management and control component at the AZ level and is responsible for management of all storage clusters in the AZ. The block storage access client may be an EBS client. A virtual machine (VM) in an ECS cluster can access block devices in different storage clusters through the EBS client, that is, the VM can send an IO request to an EBS cluster through the EBS client. The IO request includes a read request, a write request, and the like. In some scenarios, data in a source block device in a source storage cluster needs to be migrated to a target block device in a target storage cluster. For example, the source storage cluster is an EBS cluster A, the source block device is a block device A, the target storage cluster is an EBS cluster B, and the target block device is a block device B. Data in the block device A in the EBS cluster A is migrated to the block device B in the EBS cluster B.

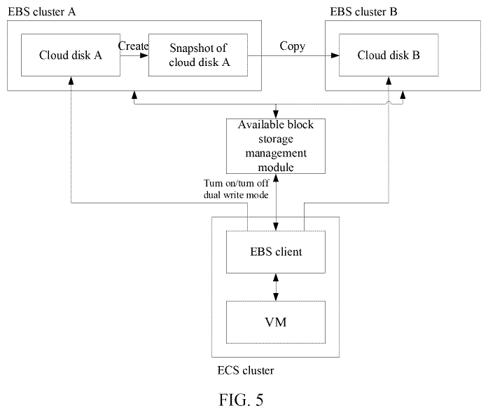

Referring to FIG. 5, it illustrates a schematic diagram of a practical application scenario of a data migration method based on a storage cluster in an embodiment of the present disclosure.

In the embodiment of the present disclosure, data in a source block device in a source storage cluster needs to be migrated to a target block device in a target storage cluster. The following uses an example in which the source storage cluster is an EBS cluster A, the source block device is a block device A, the target storage cluster is an EBS cluster B, the target block device is a block device B, and data in the block device A in the EBS cluster A is migrated to the block device B in the EBS cluster B for description.

The available block storage management module triggers the EBS cluster B to create the block device B, and sends an instruction for turning on a dual write mode to the EBS client. The EBS client determines a first synchronization point of an IO request, and sends write mode switching completion information to the available block storage management module after finishing processing preceding IOs issued before the first synchronization point. After receiving the write mode switching completion information, the available block storage management module triggers the EBS cluster A to create a block device A snapshot of the block device A. The subsequent IOs issued after the first synchronization point are sent to the block device A and the block device B at the same time by the EBS client.

It may be understood that the source block device snapshot is created after the EBS client finishes processing the IOs issued before the first synchronization point, so the source block device snapshot includes all content of the existing data, which can ensure the consistency after the data migration. Since there may be a time difference between sending the IO request to the source block device and the snapshot data, the snapshot data may further include some data written by the IOs issued after the first synchronization point. These data also exist in the target block device at the same time, and the generation of some redundant data does not affect the data consistency.

The available block storage management module sends the snapshot information of the source block device snapshot to the EBS cluster B, and the EBS cluster B copies the block device A snapshot to the block device B. When the available block storage management module detects that the copying is completed, it sends an instruction for turning off the dual write mode to the EBS client. The EBS client determines a second synchronization point of the IO request. After finishing processing the IOs issued before the second synchronization point, the EBS client stops sending the IOs issued after the second synchronization point to the block device A, and only sends the IOs issued after the second synchronization point to the block device B, thereby completing the process of data migration.

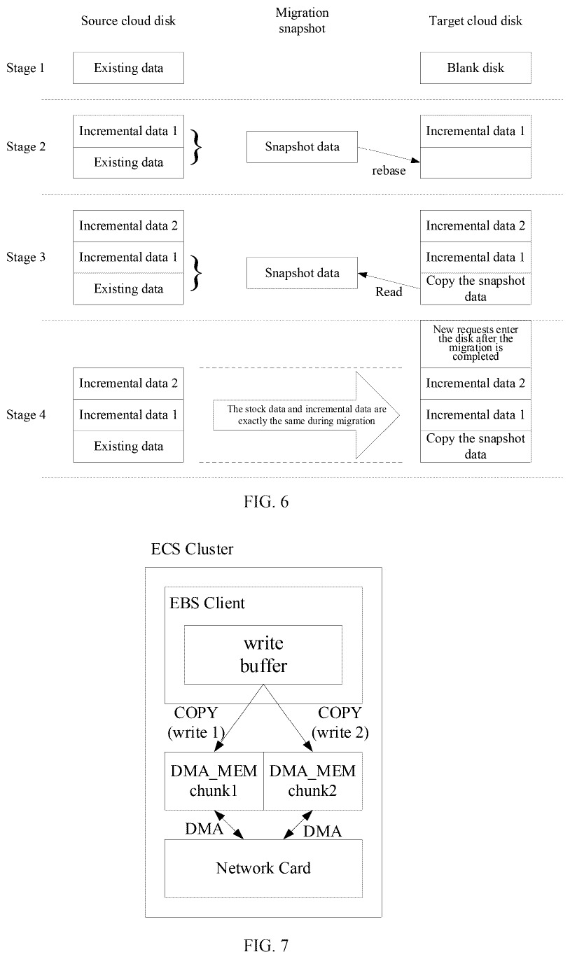

Referring to FIG. 6, it illustrates a schematic diagram of a process of data migration after the EBS client turns on the dual write mode in the embodiment of the present disclosure. In stage 1, data migration starts, the original existing data is stored in the source block device, and the target block device is created. In stage 2, the EBS client receives an instruction for turning on the dual write mode, and starts to send IO requests to both the source block device and the target block device at the same time after finishing processing the IOs issued before the first synchronization point, and incremental data 1 is generated in the source block device and the target block device. Then a source block device snapshot is created, and the snapshot data includes the existing data and the incremental data 1. The snapshot data is used as a basis for data migration of the target block device. In stage 3, the target block device copies the snapshot data, and the EBS client sends IO requests to both the source block device and the target block device at the same time, and incremental data 2 is generated in the source block device and the target block device. In stage 4, the copying is completed, the EBS client receives an instruction for turning off the dual write mode, and after finishing processing the IOs issued before the second synchronization point, only sends the IO requests to the target block device. In this way, the existing data and the incremental data are completely consistent in the data migration process, and some redundant incremental data 1 exists in the target block device, but the consistency of data migration is not affected. The existing data is migrated in parallel on the cluster side, and the incremental data is ensured to be synchronized by the dual write mode, and the smooth switching between turning on and turning off the dual write mode ensures that the whole process is imperceptible to users.

In order to ensure the performance of the dual write mode of the block storage access client, the embodiment of the present disclosure further optimizes the write mode of the block storage access client.

In a possible implementation, the specific implementation of implementing the incremental data synchronization to the source storage cluster and the target storage cluster by executing the dual write mode may include:
before the incremental data is written, first applying for a DMA memory, storing the incremental data in the DMA memory, and then sending the incremental data to the source storage cluster and the target storage cluster by using the DMA memory.

When a user-mode transport protocol is used, such as user-mode TCP (Transmission Control Protocol), RDMA (Remote Direct Memory Access), etc., the application layer data usually needs to be copied into the DMA memory DMA_MEM to be sent by the network card, and one write request needs to go through one copy of the user writing buffer to the DMA memory. Referring to FIG. 7, it illustrates a schematic diagram of sending a write request in a dual write mode in the prior art. In the dual write mode, the existing solution requires two copies of the user buffer to the DMA memory.

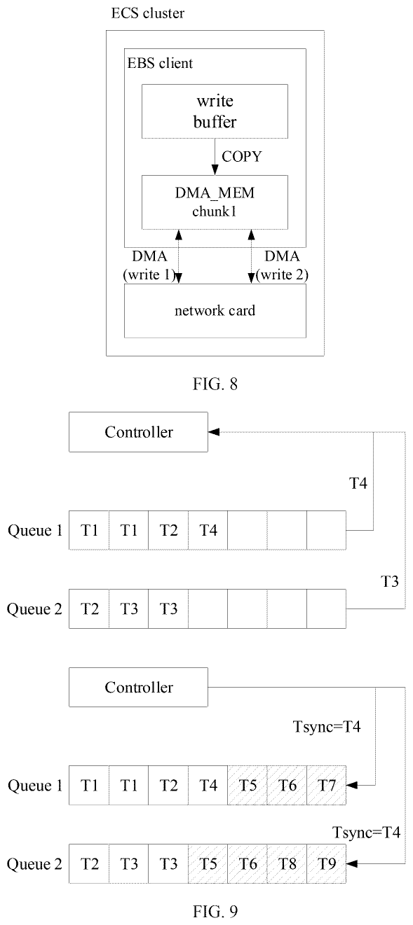

Referring to FIG. 8, it illustrates a schematic diagram of sending a write request in a dual write mode in the embodiment of the present disclosure. Since the write data in the dual write mode is unchanged, in the embodiment of the present disclosure, the DMA memory is applied for in advance at the application layer of the block storage access client, and the user buffer data (that is, the write data of the write request) is copied to the DMA memory. When the write data is directly stored in the DMA memory, the network card can directly send the write data. Then the DMA memory can be directly used to perform two data sending operations, thereby reducing one copy overhead and optimizing the throughput and latency of the dual write mode.

In the embodiment of the present disclosure, the DMA memory is pre-allocated, and the two data copy overheads are reduced to one, thereby greatly optimizing the performance overhead of the dual write mode, and making the performance of the dual write mode basically the same as the performance of the single write mode.

In order to ensure the smooth write mode switching of the EBS client, the embodiment of the present disclosure provides a two-stage write mode switching mechanism.

In a possible implementation, the specific implementation of determining the first synchronization point of executing the dual write mode in response to the instruction for turning on the dual write mode may include the following.
A1: In response to the instruction for turning on the dual write mode, notifying, by a controller, each IO queue to hang a foreground IO, and determining a largest IO sequence number among all the IO queues as the first synchronization point of executing the dual write mode, where the sequence numbers of IOs in the each IO queue are sequentially allocated according to a sequence number ascending order based on the sequence of the time when the IOs are received.
A2: Sending, by the controller, the first synchronization point to each IO queue, notifying each IO queue to resume the foreground IO, waiting for all IOs that are less than or equal to the first synchronization point to be completed and then returning a dual write switch success, and controlling all IOs that are greater than the first synchronization point to be processed in the dual write mode.

A traditional HDD (Hard Disk Drive) device usually has only one queue, and the latency itself is relatively high, so the simplest IO Fencing can be used to implement this. The foreground IO request is hanged, and the hanged IO is re-issued after waiting for the flying IO request to complete landing, so that the above requirements can be met. However, storage media today are changing with each passing day, and the performance is continuously improved. In order to achieve higher throughput capability, multiple queues are usually supported. For example, the nvme protocol supports a maximum of 64K queues, and the concurrency capability of IO requests is greatly improved. In a high-performance storage application scenario, when there are a large number of concurrent IO requests, all foreground hanged IO requests need to complete landing from the slowest IO request before the synchronization point, and ordinary IO Fencing is likely to bring obvious long-tail IO latency.

To solve the above problem, the embodiment of the present disclosure designs a two-stage write mode switching mechanism supporting multiple queues to implement smooth write mode switching. First, an IO sequence number allocator needs to be implemented. When an IO request is received, a sequence number is allocated to each IO request to ensure that an earlier IO request has a smaller sequence number, and a later IO has a larger sequence number. In a scenario of multiple queues and multiple threads, a time stamp may be used as the sequence number, or a variable combined with a CAS instruction may be used to complete the allocation of the sequence number. The IO sequence number allocator ensures the semantics of the synchronization point in the embodiment of the present disclosure.

Then, in a possible implementation, the method further includes: in response to receiving an IO, using a time stamp of the time when the IO is received as the sequence number of the IO; or using a variable combined with a CAS instruction to allocate the sequence number of the IO.

Then, in the first stage of the two-stage write mode switching mechanism, the block storage access client receives the instruction for turning on the dual write mode, notifies each IO queue to hang the foreground IO request, and returns the current largest IO sequence number of each IO queue. After all the IO queues respond, the largest IO sequence number is taken as the maximum value, and the obtained value is the first synchronization point.

In the second stage of the two-stage write mode switching mechanism, the first synchronization point is sent to each IO queue, and each IO queue immediately resumes the foreground IO, and all IO requests greater than the first synchronization point are processed in the new way and sent to the source storage cluster and the target source storage cluster at the same time. Each IO queue waits for all IO requests less than or equal to the first synchronization point to be completed, and returns the first switching completion feedback information. After receiving the first switching completion feedback information from all IO queues, the block storage access client can send the write mode switching completion information to the block storage availability zone management server.

Referring to FIG. 9, it illustrates a schematic diagram of the two-stage write mode switching mechanism provided by the embodiment of the present disclosure. The block storage access client may include a controller. In the first stage of the two-stage write mode switching mechanism, after receiving the instruction for turning on the dual write mode, the controller notifies each IO queue to hang the foreground IO request, and returns the current largest IO sequence number of each IO queue. After all the IO queues respond, the controller takes the largest IO sequence number as the maximum value, and the obtained value is the sequence number Tsync of the first synchronization point, for example, Tsync is T4.

In the second stage of the two-stage write mode switching mechanism, the controller sends the sequence number Tsync of the first synchronization point to each IO queue, and each IO queue immediately resumes the foreground IO, and all IOs greater than Tsync are processed in the dual write mode, for example, the IO requests in the shaded part in the figure are processed in the dual write mode. Each IO queue waits for all IO requests less than or equal to Tsync to be completed, and returns to the controller that the switching is completed, that is, returns the first switching completion feedback information. After all the IO queues complete the switching, the turning on of the dual write mode is completed.

In the embodiment of the present disclosure, the communication between the controller and each IO queue is implemented by configuring two lock-free queues in a polling mode. One lock-free queue stores requests from the controller to each IO queue, and another lock-free queue stores responses from each IO queue to the controller.

In the embodiment of the present disclosure, it is ensured that the influence time of the IO request only involves the notification time-consuming between the controller and the IO queues, including the controller notifying each IO queue to hang the foreground IO request, each IO queue returning the current largest IO sequence number, and the controller sending the first synchronization point to each IO queue. Theoretically, there is only influence time at the microsecond level, which avoids long-term IO request blocking caused by waiting for the completion of the IO request before the synchronization point.

In order to ensure that the notification latency between the controller and the IO queues is small enough, the communication mechanism between the controller and the IO queues is implemented by configuring two lock-free queues in a polling mode. The two lock-free queues store the notifications from the controller to the IO queues and the responses from the IO queues to the controller. The lock-free queue and the polling mechanism ensure that the notifications in the two-stage write mode switching mechanism can be processed as soon as possible within a minimal latency, and ensure that the latency does not fluctuate.

In addition, waiting for the completion of the IO request before the first synchronization point before returning the switching completion also ensures the consistency of the data migration data. The IO Fencing is divided into two-stage processing, and the write mode switching can be completed very smoothly in a high-throughput scenario with multiple queues, ensuring that the user performance is not damaged during data migration.

Similarly, when the dual write mode is turned off, the above-mentioned two-stage write mode switching mechanism may also be used.

In a possible implementation, determining the second synchronization point of turning off the dual write mode in response to the instruction for turning off the dual write mode includes the following.
B1: In response to the instruction for turning off the dual write mode, notifying, by a controller, each IO queue to hang a foreground IO, and determining a largest IO sequence number among all the IO queues as the second synchronization point of executing the dual write mode, where the sequence numbers of IOs in the each IO queue are sequentially allocated according to a sequence number ascending order based on the sequence of the time when the IOs are received.
B2: Sending, by the controller, the second synchronization point to each IO queue, notifying each IO queue to resume the foreground IO, waiting for all IOs that are less than or equal to the second synchronization point to be completed and then returning a single write switch success, and controlling all IOs that are greater than the second synchronization point to be processed in the single write mode.

In the first stage of the two-stage write mode switching mechanism, the block storage access client receives the instruction for turning off the dual write mode, notifies each IO queue to hang the foreground IO request, and returns the current largest IO sequence number of each IO queue. After all the IO queues respond, the largest IO sequence number is taken as the maximum value, and the obtained value is the second synchronization point.

In the second stage of the two-stage write mode switching mechanism, the second synchronization point is sent to each IO queue, and each IO queue immediately resumes the foreground IO, and all IO requests greater than the second synchronization point are processed in the new way and only sent to the target storage cluster. Each IO queue waits for all IO requests less than or equal to the second synchronization point to be completed, and returns the second switching completion feedback information. After receiving the second switching completion feedback information from all IO queues, the block storage access client can determine that the switching is completed. At this time, no IO request is sent to the source storage cluster, and only the IO request is sent to the target storage cluster to execute the single write mode.

In the embodiment of the present disclosure, the two-stage write mode switching mechanism with multiple queues combines multiple technologies, including an IO sequence number allocator, a two-stage timing synchronization mechanism, message notification based on a lock-free queue, etc., which can realize smooth write mode switching in a high-throughput scenario with multiple queues, greatly optimize the user IO interruption time in data migration, and ensure that the user performance is not damaged during data migration.

In addition, in the process of data migration, since the block storage access client turns on the dual write mode and the IO request is still written into the source storage cluster, the data migration process can be rolled back at any time. That is, in response to a data migration rollback instruction, the block storage availability zone management server can trigger the block storage access client to stop sending the IO request to the target storage cluster, that is, switch from the dual write mode back to the single write mode in which the IO request is only sent to the source storage cluster. Then the target block device in the target storage cluster is deleted, so that the rollback of data migration can be realized.

Based on the description of the above embodiments, in the embodiment of the present disclosure, in a high-throughput usage scenario, the data migration is basically imperceptible to users, and the switching of the storage cluster for data migration does not cause IO request jitter.

In the prior art, it is assumed that the upper limit of the throughput of the block device used by the user is 350 MB/s, and the data replication speed is 500 MB/s. Assuming that the time-consuming of the last data synchronization without pausing the foreground IO request is 20 seconds, and the user continues to write at the maximum throughput during the data synchronization, the time-consuming of the last data synchronization after pausing the IO request is 350*20/500=14 seconds, and the user can perceive a 14-second increase in the IO request latency. Similarly, even if the time-consuming of the last data synchronization without pausing the foreground IO request is optimized to 3 seconds, the user can perceive a maximum increase of 2.1 seconds in the IO latency.

In the embodiments of the present disclosure, regardless of the upper limit of the throughput of the user's block device and the data replication speed, the IO jitter time only depends on the latency of the IO fencing message notification in the block storage access client. Each queue includes two lock-free queue message communications in the first stage and one lock-free queue message communication in the second stage. Assuming that the message communication latency of a lock-free queue is L (usually within 10 us, Ln represents the latency of queue n). IO influence time=max(2*L1, 2*L2, . . . 2*Ln)+max (L1, L2, . . . . Ln)≈30 us, and the IO jitter is expected to be reduced to about 30 us. The influence of the data migration latency is expected to be smoother and more controllable, and the latency influence is in the microsecond range.

Based on the data migration method based on a storage cluster provided by the above method embodiments, the embodiments of the present disclosure further provide a data migration system based on a storage cluster, which will be described below with reference to the drawings.

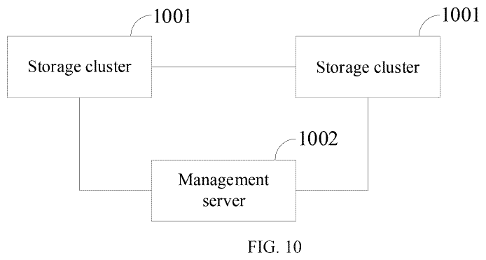

Referring to FIG. 10, this figure is a schematic structural diagram of a data migration system based on a storage cluster provided by an embodiment of the present disclosure. As shown in FIG. 10, the data migration system includes:
a plurality of storage clusters 1001 and a management server 1002 configured to manage and control the plurality of storage clusters, where

the management server 1002 is configured to: trigger a dual write mode of a block storage access client in response to a data migration instruction, and implement incremental data synchronization to a source storage cluster and a target storage cluster by executing the dual write mode, where the data migration instruction is used to instruct to migrate data in the source storage cluster to the target storage cluster; and trigger a storage node in the source storage cluster to generate corresponding snapshot data for existing data in response to the data migration instruction, and migrate the snapshot data to the target storage cluster.

In a possible implementation, the system further includes a cloud computing cluster, the cloud computing cluster is provided with a block storage access client, and the cloud computing cluster is configured to:
before the incremental data is written, first applying for a direct memory access (DMA) memory, storing the incremental data in the DMA memory, and then sending the incremental data to the source storage cluster and the target storage cluster by using the DMA memory.

In a possible implementation, the cloud computing cluster is further configured to:
determine a first synchronization point for executing a dual write mode in response to an instruction for turning on the dual write mode, where the first synchronization point is used to instruct to first land all preceding IOs issued before the first synchronization point and then process subsequent IOs issued after the first synchronization point in the dual write mode.

In a possible implementation, the cloud computing cluster is further configured to:
in response to the instruction for turning on the dual write mode, notifying, by a controller, each IO queue to hang a foreground IO, and determining, a largest IO sequence number among all the IO queues as the first synchronization point for executing the dual write mode, where the sequence numbers of IOs in the each IO queue are sequentially allocated according to a sequence number ascending order based on the sequence of the time when the IOs are received; and
sending, by the controller, the first synchronization point to each IO queue, notifying each IO queue to resume the foreground IO, waiting for all IOs that are less than or equal to the first synchronization point to be completed and then returning a dual write switch success, and controlling all IOs that are greater than the first synchronization point to be processed in the dual write mode.

In a possible implementation, the cloud computing cluster is further configured to:
determine a second synchronization point of turning off the dual write mode in response to an instruction for turning off the dual write mode, where the second synchronization point is used to instruct to first land all IOs issued before the second synchronization point in the dual write mode and then process IOs issued after the second synchronization point in the single write mode.

In a possible implementation, the cloud computing cluster is further configured to:
in response to the instruction for turning off the dual write mode, notifying, by a controller, each IO queue to hang a foreground IO, and determining a largest IO sequence number among all the IO queues as the second synchronization point for executing the dual write mode, where the sequence numbers of IOs in the each IO queue are sequentially allocated according to a sequence number ascending order based on the sequence of the time when the IOs are received; and
sending, by the controller, the second synchronization point to each IO queue, notifying each IO queue to resume the foreground IO, waiting for all IOs that are less than or equal to the second synchronization point to be completed and then returning a single write switch success, and controlling all IOs that are greater than the second synchronization point to be processed in the single write mode.

In a possible implementation, the cloud computing cluster is further configured to:
in response to receiving an IO, using a time stamp of the time when the IO is received as the sequence number of the IO; or using a variable combined with a CAS instruction to allocate the sequence number of the IO.

In a possible implementation, the communication between the controller and each IO queue is implemented by configuring two lock-free queues in a polling mode. One lock-free queue stores requests from the controller to each IO queue, and the other lock-free queue stores responses from each IO queue to the controller.

In addition, an embodiment of the present disclosure further provides a computer-readable storage medium. The computer-readable storage medium stores instructions which, when executed by a terminal device, cause the terminal device to perform the data migration method based on a storage cluster as described above.

An embodiment of the present disclosure further provides a computer program product, including computer program instructions which, when executed by a computer, cause the computer to perform the data migration method based on the storage cluster as described above.

In the embodiments of the present disclosure, a block storage availability zone management server can respond to a data migration instruction to migrate data in a source storage cluster to a target storage cluster. In the process of data migration, a dual write mode of a block storage access client is triggered, and incremental data synchronization to the source storage cluster and the target storage cluster is implemented by executing the dual write mode. The storage node in the source storage cluster is further triggered to generate corresponding snapshot data for existing data and migrate the snapshot data to the target storage cluster. In this way, the existing data is migrated to the target storage cluster through the snapshot data, while the incremental data is directly sent to the source storage cluster and the target storage cluster. Only when the dual write mode of the block storage access client is triggered, the IO request is paused at the microsecond level, and the IO request interruption time in the data migration process is extremely short, which is basically imperceptible to users.

It should be noted that the embodiments in the present specification are described in a progressive manner, and each embodiment focuses on differences from other embodiments, and the same or similar parts between the embodiments may be referred to each other. For the system or apparatus disclosed in the embodiments, since it corresponds to the method disclosed in the embodiments, the description is relatively simple, and reference may be made to the description of the method for related parts.

It should be understood that, in the present disclosure, “at least one” means one or more, and “a plurality of” means two or more. “And/or” is used to describe an association relationship of associated objects, indicating that there may be three relationships, for example, “A and/or B” may represent: only A exists, only B exists, and both A and B exist at the same time, where A and B may be singular or plural. The character “/” generally represents that the associated objects before and after are in an “or” relationship. “At least one of the following” or similar expressions thereof refer to any combination of these items, including any combination of a single item (a) or a plurality of items (a). For example, at least one of a, b or c may represent: a, b, c, “a and b”, “a and c”, “b and c”, or “a and b and c”, where a, b, c may be single or plural.

It should also be noted that, in this text, relational terms such as first and second are only used to distinguish one entity or operation from another entity or operation, and do not necessarily require or imply the existence of any such actual relationship or order between these entities or operations. Moreover, the term “include/comprise” or any other variation thereof is intended to cover non-exclusive inclusion, so that a process, method, article, or device including a series of elements not only includes these elements, but also includes other elements not explicitly listed, or also includes elements inherent to such a process, method, article, or device. Without more restrictions, elements defined by the statement “include/comprise one” do not exclude the existence of other identical elements in the process, method, article, or device including the elements.

The steps of the method or algorithm described in combination with the embodiments disclosed in this text may be implemented directly by hardware, software modules executed by a processor, or a combination thereof. The software module may be placed in a random-access memory (RAM), a memory, a read-only memory (ROM), an electrically programmable ROM, an electrically erasable programmable ROM, a register, a hard disk, a removable magnetic disk, a CD-ROM, or any other form of storage medium well-known in the technical field.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments shown in this text, but will conform to the widest scope consistent with the principles and novel features disclosed in this text.

1. A data migration method based on a storage cluster, comprising:
triggering a dual write mode of a block storage access client in response to a data migration instruction, and implementing incremental data synchronization to a source storage cluster and a target storage cluster by executing the dual write mode, wherein the data migration instruction is used to instruct to migrate data in the source storage cluster to the target storage cluster; and
triggering a storage node in the source storage cluster to generate corresponding snapshot data for existing data in response to the data migration instruction, and migrating the snapshot data to the target storage cluster.

2. The method according to claim 1, wherein the implementing incremental data synchronization to a source storage cluster and a target storage cluster by executing the dual write mode comprises:
before the incremental data is written, first applying for a direct memory access (DMA) memory, storing the incremental data in the DMA memory, and then sending the incremental data to the source storage cluster and the target storage cluster by using the DMA memory.

3. The method according to claim 1, wherein the triggering a dual write mode of a block storage access client comprises:
determining a first synchronization point for executing the dual write mode in response to an instruction for turning on the dual write mode, wherein the first synchronization point is used to instruct to first land all preceding input/output IOs issued before the first synchronization point and then process subsequent IOs issued after the first synchronization point in the dual write mode.

4. The method according to claim 3, wherein the determining a first synchronization point for executing the dual write mode in response to an instruction for turning on the dual write mode comprises:
in response to the instruction for turning on the dual write mode, notifying, by a controller, each IO queue to hang a foreground IO, and determining a largest IO sequence number among all IO queues as the first synchronization point for executing the dual write mode, wherein sequence numbers of IOs in each IO queue are sequentially allocated according to a sequence number ascending order based on a sequence of time when the IOs are received; and
sending, by the controller, the first synchronization point to each IO queue, notifying each IO queue to resume the foreground IO, waiting for all IOs that are less than or equal to the first synchronization point to be completed and then returning a dual write switch success, and controlling all IOs that are greater than the first synchronization point to be processed in the dual write mode.

5. The method according to claim 1, further comprising:
determining a second synchronization point of turning off the dual write mode in response to an instruction for turning off the dual write mode, wherein the second synchronization point is used to instruct to first land all IOs issued before the second synchronization point in the dual write mode and then process IOs issued after the second synchronization point in a single write mode.

6. The method according to claim 5, wherein the determining a second synchronization point of turning off the dual write mode in response to an instruction for turning off the dual write mode comprises:
in response to the instruction for turning off the dual write mode, notifying, by a controller, each IO queue to hang a foreground IO, and determining a largest IO sequence number among all IO queues as the second synchronization point for executing the dual write mode, wherein sequence numbers of IOs in each IO queue are sequentially allocated according to a sequence number ascending order based on a sequence of time when the IOs are received; and
sending, by the controller, the second synchronization point to each IO queue, notifying each IO queue to resume the foreground IO, waiting for all IOs that are less than or equal to the second synchronization point to be completed and then returning a single write switch success, and controlling all IOs that are greater than the second synchronization point to be processed in the single write mode.

7. The method according to claim 4, further comprising:
in response to receiving an IO, using a time stamp of a time when the IO is received as a sequence number of the IO; or using a variable combined with a Compare And Swap (CAS) instruction to allocate the sequence number of the IO.

8. The method according to claim 4, wherein communication between the controller and each IO queue is implemented by configuring two lock-free queues in a polling mode, one of the two lock-free queues stores requests from the controller to each IO queue, and another lock-free queue stores responses from each IO queue to the controller.

9. The method according to claim 6, further comprising:
in response to receiving an IO, using a time stamp of a time when the IO is received as a sequence number of the IO; or using a variable combined with a Compare And Swap (CAS) instruction to allocate the sequence number of the IO.

10. The method according to claim 6, wherein communication between the controller and each IO queue is implemented by configuring two lock-free queues in a polling mode, one of the two lock-free queues stores requests from the controller to each IO queue, and another lock-free queue stores responses from each IO queue to the controller.

11. A data migration system based on a storage cluster, characterized in that the system comprises:
a plurality of storage clusters and a management server configured to manage and control the plurality of storage clusters,
wherein the management server is configured to: trigger a dual write mode of a block storage access client in response to a data migration instruction, and implement incremental data synchronization to a source storage cluster and a target storage cluster by executing the dual write mode, wherein the data migration instruction is used to instruct to migrate data in the source storage cluster to the target storage cluster; and trigger a storage node in the source storage cluster to generate corresponding snapshot data for existing data in response to the data migration instruction, and migrate the snapshot data to the target storage cluster.

12. The system according to claim 11, further comprising a cloud computing cluster, the cloud computing cluster is provided with a block storage access client, and the cloud computing cluster is configured to:
before the incremental data is written, first applying for a direct memory access (DMA) memory, storing the incremental data in the DMA memory, and then sending the incremental data to the source storage cluster and the target storage cluster by using the DMA memory.

13. The system according to claim 11, wherein the cloud computing cluster is further configured to:
determine a first synchronization point for executing a dual write mode in response to an instruction for turning on the dual write mode, where the first synchronization point is used to instruct to first land all preceding IOs issued before the first synchronization point and then process subsequent IOs issued after the first synchronization point in the dual write mode.

14. The system according to claim 13, wherein the cloud computing cluster is further configured to:
in response to the instruction for turning on the dual write mode, notifying, by a controller, each IO queue to hang a foreground IO, and determining, a largest IO sequence number among all the IO queues as the first synchronization point for executing the dual write mode, where the sequence numbers of IOs in the each IO queue are sequentially allocated according to a sequence number ascending order based on the sequence of the time when the IOs are received; and
sending, by the controller, the first synchronization point to each IO queue, notifying each IO queue to resume the foreground IO, waiting for all IOs that are less than or equal to the first synchronization point to be completed and then returning a dual write switch success, and controlling all IOs that are greater than the first synchronization point to be processed in the dual write mode.

15. The system according to claim 11, wherein the cloud computing cluster is further configured to:
determine a second synchronization point of turning off the dual write mode in response to an instruction for turning off the dual write mode, where the second synchronization point is used to instruct to first land all IOs issued before the second synchronization point in the dual write mode and then process IOs issued after the second synchronization point in the single write mode.

16. The system according to claim 15, wherein the cloud computing cluster is further configured to:
in response to the instruction for turning off the dual write mode, notifying, by a controller, each IO queue to hang a foreground IO, and determining a largest IO sequence number among all the IO queues as the second synchronization point for executing the dual write mode, where the sequence numbers of IOs in the each IO queue are sequentially allocated according to a sequence number ascending order based on the sequence of the time when the IOs are received; and
sending, by the controller, the second synchronization point to each IO queue, notifying each IO queue to resume the foreground IO, waiting for all IOs that are less than or equal to the second synchronization point to be completed and then returning a single write switch success, and controlling all IOs that are greater than the second synchronization point to be processed in the single write mode.

17. A non-transitory computer-readable storage medium, characterized in that the computer-readable storage medium stores instructions which, when executed by a terminal device, cause the terminal device to perform a data migration method based on a storage cluster, and the method comprises:
triggering a dual write mode of a block storage access client in response to a data migration instruction, and implementing incremental data synchronization to a source storage cluster and a target storage cluster by executing the dual write mode, wherein the data migration instruction is used to instruct to migrate data in the source storage cluster to the target storage cluster; and
triggering a storage node in the source storage cluster to generate corresponding snapshot data for existing data in response to the data migration instruction, and migrating the snapshot data to the target storage cluster.

18. The non-transitory computer-readable storage medium according to claim 17, wherein the implementing incremental data synchronization to a source storage cluster and a target storage cluster by executing the dual write mode comprises:
before the incremental data is written, first applying for a direct memory access (DMA) memory, storing the incremental data in the DMA memory, and then sending the incremental data to the source storage cluster and the target storage cluster by using the DMA memory.

19. The non-transitory computer-readable storage medium according to claim 17, wherein the triggering a dual write mode of a block storage access client comprises:
determining a first synchronization point for executing the dual write mode in response to an instruction for turning on the dual write mode, wherein the first synchronization point is used to instruct to first land all preceding input/output IOs issued before the first synchronization point and then process subsequent IOs issued after the first synchronization point in the dual write mode.

20. The non-transitory computer-readable storage medium according to claim 19, wherein the determining a first synchronization point for executing the dual write mode in response to an instruction for turning on the dual write mode comprises:
in response to the instruction for turning on the dual write mode, notifying, by a controller, each IO queue to hang a foreground IO, and determining a largest IO sequence number among all IO queues as the first synchronization point for executing the dual write mode, wherein sequence numbers of IOs in each IO queue are sequentially allocated according to a sequence number ascending order based on a sequence of time when the IOs are received; and
sending, by the controller, the first synchronization point to each IO queue, notifying each IO queue to resume the foreground IO, waiting for all IOs that are less than or equal to the first synchronization point to be completed and then returning a dual write switch success, and controlling all IOs that are greater than the first synchronization point to be processed in the dual write mode.
